(19) United States
(12) Patent Application Publication
(10) Pub. No.: US 2024/0204182 A1
(43) Pub. Date: Jun. 20, 2024

(54) ELECTRODE PLATE HAVING ACTIVE SUBSTANCE OF ELECTROCHEMICAL ENERGY STORAGE DEVICE

(71) Applicant: CYNTEC CO., LTD., Hsinchu (TW)

(72) Inventors: Pei-I Wei, Hsinchu (TW); Kai-Pin Huang, Hsinchu (TW); Kai-Hsiang Liang, Hsinchu (TW)

(73) Assignee: CYNTEC CO., LTD., Hsinchu (TW)

(21) Appl. No.: 18/221,857

(22) Filed: Jul. 13, 2023

Related U.S. Application Data
(60) Provisional application No. 63/432,984, filed on Dec. 15, 2022.

(51) Int. Cl. H01M 4/525; G01N 23/2251; H01M 4/133; H01M 4/62

(52) U.S. Cl. CPC H01M 4/525; G01N 23/2251; H01M 4/133; H01M 4/623; H01M 2004/021

(57) ABSTRACT

An electrode plate having active substance of electrochemical energy storage device is provided in the present invention, including a current collector and an electrode formed of active substance on the current collector, wherein the active substance includes first particles in form of spherical powder and second particles in form of monocrystalline structure, and an average particle size of the first particles is larger than or equal to three times of an average particle size of the second particles, and a volume ratio of the first particles in the active substance is greater than a volume ratio of the second particles in the active substance, and a breakage rate of said electrode formed by mixed first particles and second particles in rolling pressing process is smaller than or equal to 40%.

### CROSS REFERENCE TO RELATED APPLICATIONS

This application claims the benefit of U.S. Provisional Application No. 63/432,984, filed on Dec. 15, 2022. The content of the application is incorporated herein by reference.

### BACKGROUND OF THE INVENTION

### 1. Field of the Invention

The present invention relates generally to an electrode plate having active substance, and more specifically, to an electrode plate having active substance formed of two kinds of particles with different particle sizes and volume ratios.

### 2. Description of the Related Art

Lithium-ion battery is a kind of rechargeable battery, with its conversion of chemical energy and electrical energy is achieved through the movement of lithium ions between positive electrode plate and negative electrode plate. Since its advantages of high energy density, good stability and free of memory effect, lithium-ion battery is widely used in the fields like 3C product, power battery and energy storage battery. In order to increase the energy density of lithium-ion battery, particles of active substance are added in the electrode to increase the density of coating layer in the electrode through particle packing, wherein particles with specific sizes are used to be roll-pressed into electrode plate so as to further improve coating layer density of the electrodes by a rolling process. However, in actual implementation, many factors like crystal structure, size, mixing ratio and appearance of the particles may lead to the breakage of particles in the rolling process after particle packing, which may further lead to the permeation of electrolyte into the particle cracks and deteriorate the cycle life of batteries. Accordingly, those of skilled in the art need to further research and improve the active substance in the electrodes of lithium-ion battery, in hope of reducing breakage rate of the active substance in the rolling process.

### SUMMARY OF THE INVENTION

In the light of the aforementioned problem encountered in conventional skill, the present invention hereby provides an electrode plate having active substance of electrochemical energy storage device, with using two kinds of particles with specific sizes and volume ratios to form the active substance, so that particles in the active substance will not break easily in rolling process and obtain an optimized electrode density.

The objective of present invention is to provide an electrode plate having active substance of electrochemical energy storage device, including a current collector and an electrode formed of active substance on the current collector, wherein the active substance includes first particles in form of spherical powder and second particles in form of monocrystalline structure, and an average particle size of the first particles is larger than or equal to three times of an average particle size of the second particles, and a volume ratio of the first particles in the active substance is greater than a volume ratio of the second particles in the active substance, and a breakage rate of said electrode formed by mixed first particles and second particles in rolling pressing process is smaller than or equal to 40%.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute a part of this specification. The drawings illustrate some of the embodiments and, together with the description, serve to explain their principles. In the drawings:

FIG. 1 is a schematic view of a lithium-ion battery in accordance with an embodiment of present invention;

FIG. 2 is a schematic view of an electrode plate in accordance with another embodiment of present invention;

FIG. 3 is a schematic view illustrating two different particle packing modes due to different particle sizes;

FIG. 4 is a table listing particles with different sizes, crystal structures and appearances; and

FIG. 5 is a table listing breakage rates and densities of active substances formed of different mixed particles in samples of control group I, control group II and an embodiment.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In following detailed description of the present invention, reference is made to the accompanying drawings which form a part hereof and is shown by way of illustration and specific embodiments in which the invention may be practiced. These embodiments are described in sufficient details to enable those skilled in the art to practice the invention. Dimensions and proportions of certain parts of the drawings may have been shown exaggerated or reduced in size, for the sake of clarity and convenience in the drawings. Other embodiments may be utilized and structural, logical, and electrical changes may be made without departing from the scope of the present invention. The following detailed description, therefore, is not to be taken in a limiting sense, and the scope of the present invention is defined by the appended claims.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. Additionally, the term “based on” may be understood as not necessarily intended to convey an exclusive set of factors, but may allow for the presence of other factors not necessarily expressly described, again depending at least in part on the context.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

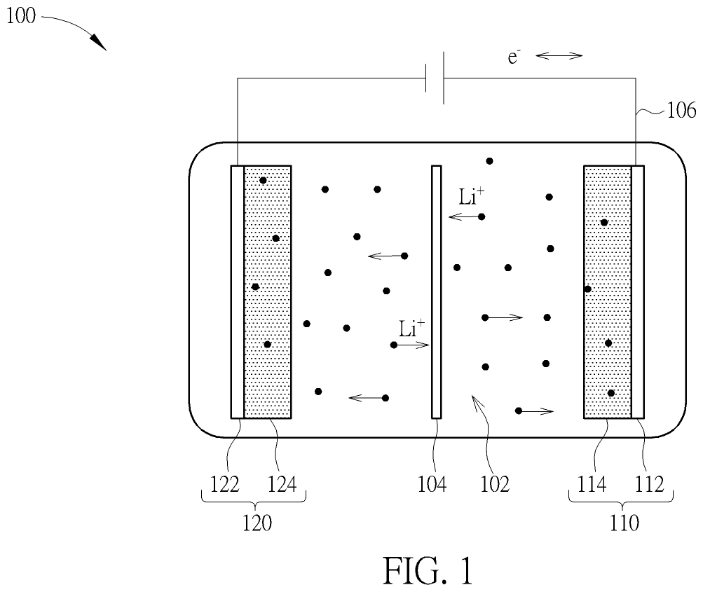

An embodiment of present invention will now be described with reference to FIG. 1, which is a schematic view of a lithium-ion battery. Although the embodiment of present invention is exemplified by the structure of lithium-ion battery, please note that the scope of present invention is not limited to lithium-ion battery, and any kind of electrode plate using active substance formed of mixed particle sources for electrochemical energy storage device can apply the principle and concept of the present invention.

Please refer to FIG. 1. A lithium-ion battery 100 generally includes a positive electrode plate 110 (also referred as a cathode where an electrode acquires electrons from the external circuit in discharging processes), a negative electrode plate 120 (also referred as an anode where the electrode releases electrons to the external circuit in discharging process), electrolyte 102 and a separator 104. In the embodiment, the positive electrode plate 110 may consist of a current collector 112 and a positive electrode 114 on the current collector 112, wherein the current collector 112 works as a support for active electrode materials and also as an electrical conductor between electrode and external circuits. The material of current collector 112 may be conductive metal like aluminum foil, with a thickness about 1-25 μm. The electrode 114 mostly uses intercalation compounds as active materials to provide spaces for releasing or receiving conductive ions. The material specific for the positive electrode 114 in the present invention may be Li-rich active substance combined with at least one transition element, for example, complex transition metal oxide such as LiNiₓCo_{y}Mn_{z}O₂ or LiNiₓCo_{y}Al_{z}O₂, wherein x+y+z=1, in the form of layer structure to provide more intercalation spaces.

With respect to negative electrode plate 120, similarly, the negative electrode plate 120 may consist of a current collector 122 and a negative electrode 124 on the current collector 122, wherein the material of current collector 122 may be conductive metal like copper foil, and the material of negative electrode 124 may be carbon, such as graphite, grapheme, or carbon nanotube, with sufficient intercalation spaces for releasing or receiving conductive ions and preventing the conductive ions accumulating therein that deteriorating the cycle life of battery. As for other components, the electrolyte 102 functions as a passage inside the batteries for current in the form of conductive ions. It may provide with better conductivity, small internal resistance, low melting point and high boiling point. The electrolyte 102 in the embodiment may consist of lithium salts and organic carbonate ester solvent, while the separator 104 is used to prevent the contact and short-circuit between the positive electrode 114 and negative electrode 124 and enable lithium ions to pass therethrough. The material of separator 104 in the embodiment may be polyolefin, such as polyethylene (PE) and polypropylene (PP).

In the charging operation of lithium-ion battery 100, lithium ions (Lit) are migrated from the Li-rich positive electrode 114 and intercalated into the negative electrode 124 which can receive the lithium ions. The migration of each lithium ion may result in the release of one electron (e), wherein the lithium ions (Lit) migrate to the negative electrode 124 through the electrolyte 102 and penetrate through the separator 104, while electrons (e) are directed from the positive electrode plate 110 to the negative electrode plate 120 through external circuit 106. In the contrast, the discharging operation of lithium-ion battery 100 is substantially a reverse process of the charging operation above. The higher the percentage of lithium ions returning back to the positive electrode 114 in the discharging operation, the better the stability and cycle life of the lithium-ion battery 100.

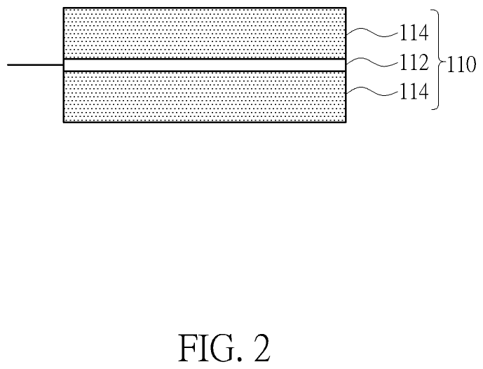

Please refer to FIG. 2, which is a schematic view of an electrode plate 110 in accordance with another embodiment of the present invention. In some embodiments, the electrode 114 may be formed on two sides of the current collector 112, in order to increase energy density and space utilization of the battery.

In the manufacture of lithium-ion battery 100, the aforementioned Li-rich active substance (ex. LiNiₓCo_{y}Mn_{z}O₂) is usually first coated on the current collector 112 (one side or both sides) and then pressed into the positive electrode 114 through a rolling process, in order to increase the packing density and reduce the thickness of positive electrode plate 110. The ratio of active substance in the electrode may be larger than 80%, while other ratio may be binder, such as polyvinylidene difluoride (PVDF), with better electrochemical stability, wettability with the electrolytes 102, and acceptable adhesion strength between electrode 114 and current collector 112. During the rolling process, the particles of Li-rich active substance in the positive electrode 114 are densely-packed and pressed. The thickness of electrode 114 after rolling may be 10-100 μm. The rolling process may easily lead to the breakage of active particles, and further lead to the permeation of electrolyte 102 into the active particle cracks and deteriorate the cycle life of batteries. This is the problem that the present invention tries to solve.

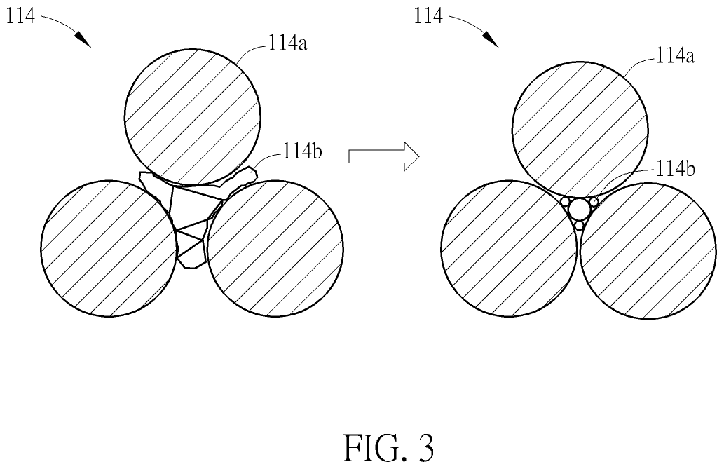

Please refer to FIG. 3, which is a schematic view illustrating two different particle packing modes resulted from the extent of particle size difference in the positive electrode 114. With respect to the active particles 114a, 114b identical or similar in size, as shown in the left part of the figure. Some of densely-packed particles 114b will inevitably break under rolling pressure, in a form of ductile packing with broken or deformed particles 114b between intact particles 114a. The more the pressure exerted in the rolling process, the higher the breakage rate of the particles. The breakage of active particles may lead to the permeation of electrolyte into the particle cracks and seriously deteriorate the cycle life of batteries. In comparison thereto, as shown in the right part of FIG. 3, the active particles 114a, 114b with quite different sizes may significantly prevent the breakage of particles, since smaller particles 114b may be easily and naturally packed and filled in the spaces between larger particles 114b during the rolling process, in a form of rigid packing with less broken or deformed particles.

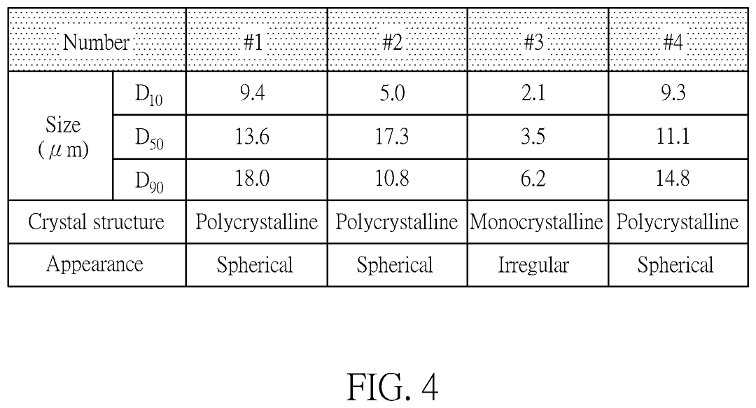

Please refer to FIG. 4. This figure shows a table listing several kinds of active particles #1 to #4 used in tests, with the same material like LiNiₓCo_{y}Mn_{z}O₂, but different particle sizes, crystal structures and appearances. The terms D10, D50 and D90 in the table are percentile values that can be read directly from the statistical parameters of cumulative particle size distribution. They indicate the size (μm) below which 10%, 50% or 90% of all particles are found, respectively. Generally, as the active substance for positive electrode of lithium-ion battery, larger particle size can provide higher mechanical strength to resist the rolling pressure and prevent particle breakage, higher tapped density to increase energy density, and smaller specific surface area (SSA) to avoid excess interface side reaction, while smaller particle can provide better fillability to fill the spaces between larger particles and prevent them from breakage in the rolling process. The crystal structure of active particles may be polycrystalline or monocrystalline. Generally, the monocrystalline particle has higher mechanical strength and less grain boundaries, so that it has better properties to prevent particle breakage resulted from pressure of the rolling process or repetitious charging/discharging cycle. However, with regard to the cost of electrode material, monocrystalline particle is more expensive than polycrystalline particle. In addition, the appearance of particles in the embodiment may be roughly divided into two kinds: spherical powder or irregular powder.

Refer still to FIG. 4. Four different particles #1 to #4 are used in a rolling test of the present invention to exemplify the relations and results between breakage rate and particle properties like aforementioned sizes, crystal structures and appearances. These particles include particles #1 featuring polycrystalline, spherical particle with size D50 about 13.6 μm, particle #2 featuring polycrystalline, spherical particle with size D50 about 7.3 μm, particle #3 featuring monocrystalline, irregular particle with size D50 about 3.5 μm, and particle #4 featuring polycrystalline, spherical particle with size D50 about 11.1 μm. As a monocrystalline particle, the porosity of particle #3 may be smaller than 1%.

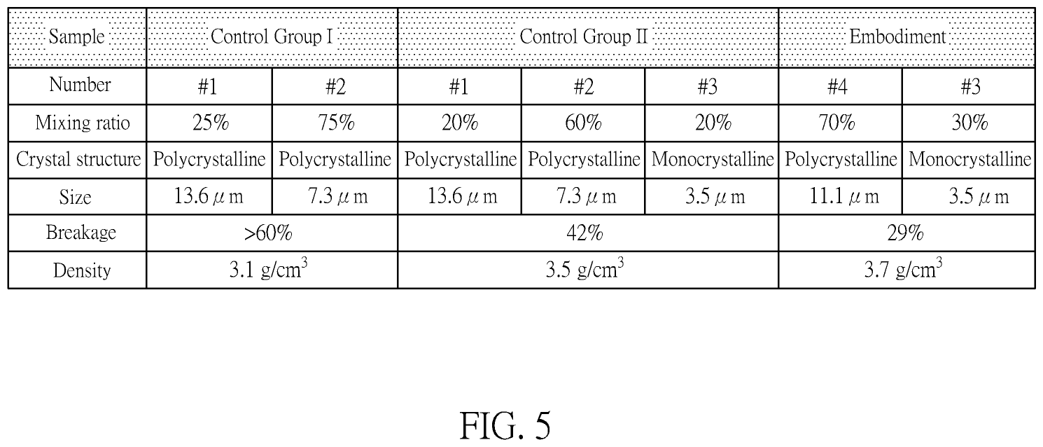

Please refer to FIG. 5. This figure shows a table listing breakage rates and electrode densities of active substances in the electrode formed of the mixed particles #1 to #4 in three test samples, including control group I, control group II and embodiment of the present invention. It can be seen in the table that control group I has highest breakage rate (>60%) among the three test samples since its mixed particles #1 and #2 are both polycrystalline, which has less resistance to the rolling process. This breakage rate is calculated by counting broken particles in one hundred particles randomly chosen from a scanning electron microscope (SEM) cross-sectional image of the electrode sample. In addition, since the average particle sizes of control group I is smaller (a large volume ratio (75%) of its particles are smaller particles #2 with average size only about 7.3 μm), its electrode density is also smaller accordingly.

With respect to control group II, as shown in the table of FIG. 4, monocrystalline particles #3 are introduced in the active substance of electrode to mix with polycrystalline particles #1 and particles #2, thus its can be expected that the breakage rate of control group II is improved and is lower than the one of control group I made of purely polycrystalline particles #1 and #2, but it is still higher than expected. This may be the result that larger particles #1 with higher mechanical strength occupies only a small volume ratio (20%) in mixed particles.

With respect to the embodiment group of present invention, as shown in the table of FIG. 4, a volume ratio 70% of large, polycrystalline particles (average size 11.1 μm) and a volume ratio 30% of smaller, monocrystalline particles (average size 3.5 μm) are mixed to form the active substance of electrode, and an improved breakage rate of 29% and a higher electrode density of 3.7 g/cm³ are achieved through this recipe in comparison to previous two control groups. The porosity of the electrode resulted from this electrode density can be smaller than 25%. This is because that a large volume ratio of larger spherical particles #4 in the mixture can provide higher packing density, and since larger particles have higher mechanical strength, they can better resist against high rolling pressure, even if they are in the form of polycrystalline. In another aspect, a small volume ratio of smaller particles #3 in the mixture can fill up the spaces between larger particles #4 to provide better mechanical strength for entire particle packing structure as shown in the right part of FIG. 3, and please note that the average particle size of larger particles #4 (11.1 μm) is larger than or equal to three times of the average particle size of smaller particles #3 (3.5 μm), this significant size difference may prevent the ductile packing mode with broken or deformed particles when the mixed particles have similar sizes, as shown in the left part of FIG. 2. In addition, irregular appearance of small particles #3 may be beneficial to the particle packing and reduce the breakage rate, and monocrystalline structure of small particles #3 may increase their mechanical strength and less grain boundaries to further prevent the particle breakage in rolling and the process in repetitious charging/discharging cycle.

According to the test above, the present invention hereby provides an electrode plate having active substance of electrochemical energy storage device, with its active substance includes first particles in form of spherical powder and second particles in form of monocrystalline structure, and the average particle size of first particles may be larger than or equal to three times of the average particle size of second particles, and a volume ratio of the first particles in the active substance may be greater than a volume ratio of the second particles in the active substance, and a breakage rate of the electrode formed by these mixed first particles and second particles in rolling pressing process is smaller than or equal to 408. The electrode density of the electrode after rolling process may be larger than 3.5 g/cm³, with the porosity of the electrode is smaller than 258. The average size of first particles may be 11.1 μm, and said average size of said second particles may be 3.5 μm, wherein the size D50 of first particles may be 8-30 μm, and the size D50 of second particles may be 1-5 μm.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrode plate having active substance of electrochemical energy storage device, comprising:
a current collector; and
an electrode formed of active substance on said current collector, wherein said active substance comprises first particles in form of spherical powder and second particles in form of monocrystalline structure;
wherein an average particle size of said first particles is larger than or equal to three times of an average particle size of said second particles, and a volume ratio of said first particles in said active substance is greater than a volume ratio of said second particles in said active substance, and a breakage rate of said electrode formed by mixed said first particles and said second particles in rolling pressing process is smaller than or equal to 40%.

2. The electrode plate having the active substance of electrochemical energy storage device of claim 1, wherein said first particles in form of polycrystalline spherical powder.

3. The electrode plate having the active substance of electrochemical energy storage device of claim 1, a density of said electrode after said rolling pressing process is larger than 3.5 g/cm³.

4. The electrode plate having the active substance of electrochemical energy storage device of claim 1, wherein a porosity of said electrode is smaller than 25%.

5. The electrode plate having the active substance of electrochemical energy storage device of claim 1, wherein said volume ratio of said first particles in said active substance is 70%, and said volume ratio of said second particles in said active substance is 30%.

6. The electrode plate having the active substance of electrochemical energy storage device of claim 1, wherein said average size of said first particles is 11.1 μm, and said average size of said second particles is 3.5 μm.

7. The electrode plate having the active substance of electrochemical energy storage device of claim 1, wherein a porosity of said second particles is smaller than 1%.

8. The electrode plate having the active substance of electrochemical energy storage device of claim 1, wherein said first particles and said second particles comprises at least one transition element.

9. The electrode plate having the active substance of electrochemical energy storage device of claim 1, wherein said breakage rate is calculated by counting broken particles in one hundred particles randomly chosen from a scanning electron microscope (SEM) cross-sectional image of said electrode.

10. The electrode plate having the active substance of electrochemical energy storage device of claim 1, wherein said electrode plate is positive electrode plate, a material of said active substance is LiNiₓCo_{y}Mn_{z}O₂, and x+y+z=1, and a ratio of said active substance is larger than 80%.

11. The electrode plate having the active substance of electrochemical energy storage device of claim 10, wherein a material of said binder is polyvinylidene difluoride (PVDF).

12. The electrode plate having the active substance of electrochemical energy storage device of claim 10, wherein a thickness of said electrode is 10-100 μm.

13. The electrode plate having the active substance of electrochemical energy storage device of claim 1, wherein said electrode plate is negative electrode plate, and a material of said electrode is graphite, graphene, or carbon nanotube.

14. The electrode plate having the active substance of electrochemical energy storage device of claim 1, wherein a material of said current collector is aluminum or copper, and a thickness of said current collector is 1-25 μm.

15. The electrode plate having the active substance of electrochemical energy storage device of claim 1, wherein D50 of said first particles is 8-30 μm, and said D50 of said second particles is 1-5 μm.

16. The electrode plate having the active substance of electrochemical energy storage device of claim 1, wherein said electrode is formed on two sides of said current collector.
